(19) United States
(12) Patent Application Publication
(10) Pub. No.: US 2016/0170041 A1
(43) Pub. Date: Jun. 16, 2016

(54) Scintillation Crystal Array with Light-Shielding for High Rate of Energy Conversion

(71) Applicant: HYPER CRYSTAL,Inc., Taipei City (TW)

(72) Inventor: Jeunn-Shenn Lee, Taipei City (TW)

(21) Appl. No.: 14/680,278

(22) Filed: Apr. 7, 2015

(30) Foreign Application Priority Data
Dec. 11, 2014 (TW) 103222029

(51) Int. Cl. G01T 1/20; G01T 1/202

(52) U.S. Cl. CPC G01T 1/2002; G01T 1/202

(57) ABSTRACT

A crystal array is provided. It is constructed with scintillation crystals. A plurality of reflecting layers and a plurality of shielding layers are formed on surface of each one of the scintillation crystals. The scintillation crystals can be adhered altogether by the shielding layers (epoxy). Or, they can be further coated with a thin film peripherally to consolidate the overall structure. On using the scintillation crystal array, a high-energy radiation, such as X-ray or y-ray, enters into each one of the scintillation crystals. Therein, light loss is minimized with high total reflection effect. Consequently, each one of the scintillation crystals fully absorbs energy of the radiation to convert the radiation into a visible light or ultraviolet with energy conversion rate improved.

### TECHNICAL FIELD OF THE INVENTION

The present invention relates to a crystal array; more particularly, relates to converting a high-energy radiation into a visible light or ultraviolet through an array of scintillation crystals, where a plurality of reflecting layers and a plurality of shielding layers are formed on surface of each one of the scintillation crystals for achieving high total reflection effect with energy conversion rate further improved.

### DESCRIPTION OF THE RELATED ART

A solid scintillation detector usually exists in a form of crystal. A scintillation crystal used in traditional nuclear medicine is mostly made into large rectangular pieces. When a radiation (X-ray or y-ray) enters into a transparent scintillation crystal, only a small part of direct or small-angle (e.g. less than 33°) radiation can enter into a photomultiplier tube (PMT) connected with the scintillation crystal. Most of the rest part of the radiation is scattered through side surface of the scintillation crystal without reaching the surface of the PMT. For effectively increasing efficiency of entering the light into the surface of the PMT, a layer of reflecting film can be pasted around the scintillation crystal to reduce light scattering at the side surface of the scintillation crystal and, furthermore, to make most of visible light entering into the PMT and increasing the number of signals. However, only about 30% of the visible light can be received by the PMT.

In recent years, due to the demand of enhancing resolution, an entire piece of a big scintillation crystal tends to be replaced by a crystal array composed of a number of small crystals. Each one of the small crystals in the crystal array shows a pixel of an image. Therefore, during showing the whole image, each one of the small crystals has to be optically isolated; that is, each one of the small crystals has to limit the generated scintillation light to enter the PMT through a respective light-guiding surface. To achieve this purpose, on forming the crystal array, the surface of each one of the crystals has to be processed to become light-shielding. After doing so, the scintillation light will travel to the surface of the crystal to be diffused or reflected and, then, return to the original crystal, where the scintillation light is thus limited.

The surface of the crystal is usually pasted with white pigment or wrapped with a Teflon film. In a general production foundry of crystal array, epoxy is mixed with a white metal oxide powder (such as MgO, TiO₂, BaSO₄, etc.) to fill the gaps in the crystal array. For example, this kind of detector was revealed in U.S. Pat. No. 5,227,634. However, the detector thus made did not have a satisfactory light-receiving performance.

In recent years, some papers have revealed methods for assembling crystal grid arrays with mirror films. They use laser to cut combs staggered on the mirror films for forming grid arrays. Then, crystals are put and fixed to form a crystal array. This method not only assembles the crystal array but also processes a light-shielding treatment. For example, the VM2000 product of enhanced specular reflector (ESR) of 3M Ltd. uses this method to make the crystal array.

Although this method has some advantages, it is difficult to be practiced. Firstly, concerning the material for the mirror film, because the crystal array is adhered to a glass surface of a photomultiplier tube (PMT), a large-gradient electric field form would be formed in the PMT by a thin glass layer; and, therefore, it must be a plastic mirror film, not a metallic one. If a metallic mirror film is used in the crystal array, statics would be accumulated owing to the nearby large electric field and the electric field thus formed by the statics would further affect the gradient of the electric field of the PMT to weaken its signals. In the market, only the bandwidth of reflecting wavelength of VM2000, which is one of the VM-series products of 3M Ltd., meets the requirement. However, VM2000 is not only expensive but also could be produced no more. Only a few can be found in some inventories, which means it is difficult to obtain the mirror film.

Secondly, concerning the laser cutting, due to a small thickness (about 0.06 mm), the plastic substrate would be easily burned even by using a low-power laser. Hence, on cutting ditches to shape the combs, the width between the ditches can not be too small, where the smallest can only be 0.1 mm and is obviously too broad for VM2000. Because the ditch is used to clamp another partition for assembling the grid, a loose structure might be formed owing to not meeting the above specification. On installing a new partition, an already-assembled partition might fall at any time. As a result, it takes time on assembling and the crystal array cannot be easily assembled. After finishing the grid by putting in the crystals, the entire crystal array is still in a loose state. Therefore, how to tighten the overall structure to form a massive one is an engineering problem to be resolved.

Hence, the prior arts do not fulfill all users' requests on actual use.

### SUMMARY OF THE INVENTION

The main purpose of the present invention is to obtain a scintillation crystal array by connecting a plurality of scintillation crystals with a plurality of reflecting layers and a plurality of shielding layers formed on surface of each one of the scintillation crystals, where light loss is minimized for achieving high total reflection effect after a high-energy radiation enters into each one of the scintillation crystals; and, thus, energy of the high-energy radiation is fully absorbed by each one of the scintillation crystals for converting the high-energy radiation into a visible light or ultraviolet with energy conversion rate further improved.

To achieve the above purpose, the present invention is a scintillation crystal array, comprising a plurality of scintillation crystals, at least one reflecting layer located on a surface of each one of said scintillation crystals; and at least one shielding layer located on a surface of said at least one reflecting layer, where the scintillation crystals are connected by the shielding layer(s) to form the scintillation crystal array. Accordingly, a novel scintillation crystal array is obtained.

### BRIEF DESCRIPTION OF THE DRAWINGS

The present invention will be better understood from the following detailed description of the preferred embodiment according to the present invention, taken in conjunction with the accompanying drawings, in which

FIG .1 is the view showing the preferred embodiment of 5×5 scintillation crystal array according to the present invention;

FIG. 2 is the explosive view showing the scintillation crystal; and

FIG. 3 is the structural view showing the scintillation crystal.

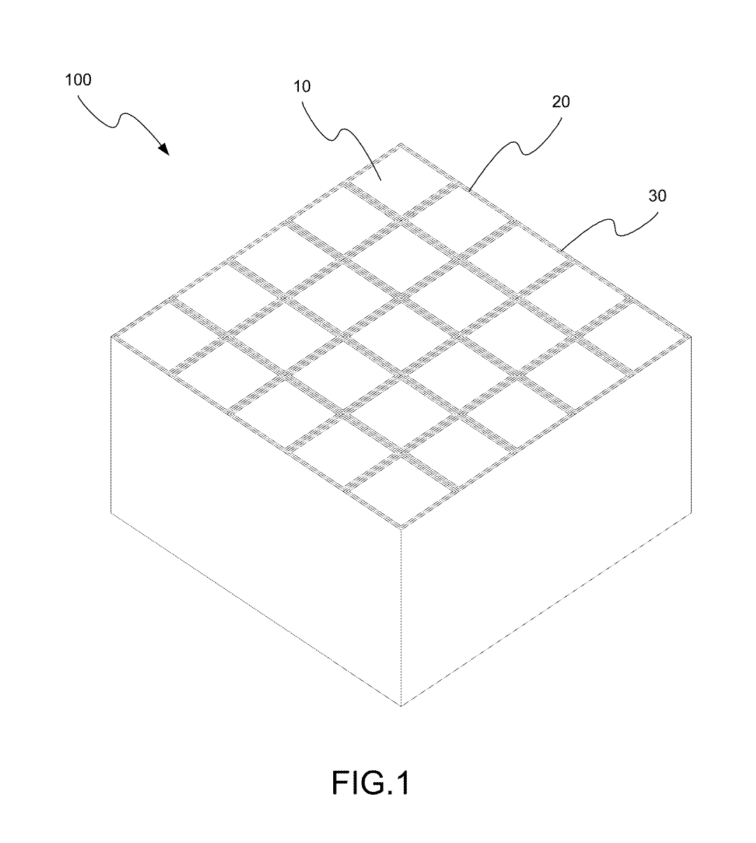

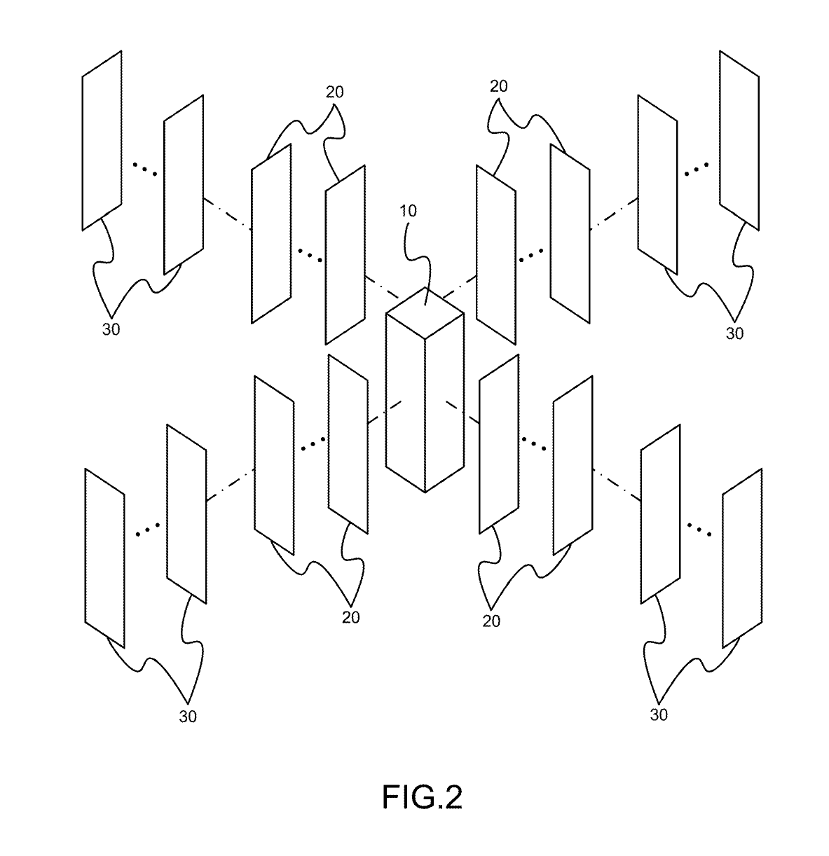

### DESCRIPTION OF THE PREFERRED EMBODIMENT

The following description of the preferred embodiment is provided to understand the features and the structures of the present invention.

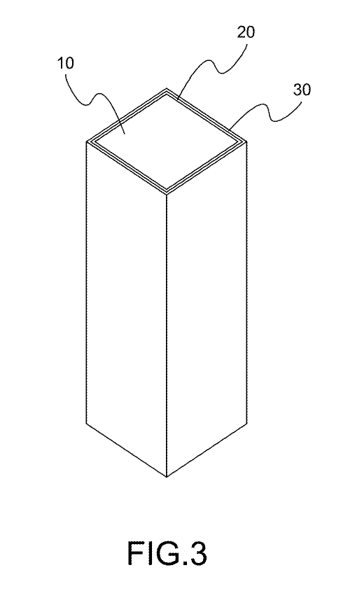

Please refer to FIG. 1˜FIG. 3, which are a view showing a preferred embodiment of 5×5 scintillation crystal array according to the present invention; and an explosive and a structural views showing a scintillation crystal. As shown in the figures, the present invention is a scintillation crystal array, comprising a plurality of scintillation crystals 10, where a plurality of reflecting layers 20 and a plurality of shielding layers 30 are set on surface of each one of the scintillation crystals 10.

The present invention can be a 5×5 scintillation crystal array 100. A plurality of the reflecting layers 20 and a plurality of the shielding layers 30 are formed on surrounding surfaces of each one of the scintillation crystals 10. Therein, the reflecting layer 20 is formed through spraying, pasting, sputtering or printing and is made of an alloy of silver, aluminum, nickel, chromium or nickel-chromium; the shielding layer 30 is a glue made of epoxy or polyvinyl acetate (PVA); and the scintillation crystals 10 are connected by the shielding layers 30 to form the scintillation crystal array 100.

The shielding layers 30 can be made of titanium dioxide (TiO₂), magnesium oxide (MgO) or barium sulfate (BaSO₄), or the glue can further comprises TiO₂, MgO or BaSO₄, for connecting the scintillation crystals 10 to form the scintillation crystal array 100.

The scintillation crystal array 10 can be further covered with a thin film (not shown the figures) peripherally for strengthening structure, where the thin film is opaque and viscous, such as a self-adhesive aluminum foil.

Thus, in the present invention, a plurality of the reflecting layers 20 and a plurality of the shielding layers 30 are formed on the surface of the scintillation crystals 10; and the shielding layers (epoxy) 30 is adhered between the scintillation crystals 10, where the scintillation crystal array 100 can be consolidated by being further coated with the thin film peripherally. On using the present invention, the scintillation crystal array 100 has a high-energy radiation, such as X-ray or y-ray, entering into each one of the scintillation crystals 10 with minimized light loss for achieving high total reflection effect. Consequently, the energy of the radiation is fully absorbed by each one of the scintillation crystals 10 to convert the radiation into a visible light or ultraviolet with energy conversion rate further improved.

To sum up, the present invention is a scintillation crystal array, where, through forming a plurality of reflecting layers and a plurality of shielding layers on surface of each one of scintillation crystals and connecting the scintillation crystals to form a scintillation crystal array, light loss is minimized for achieving high total reflection effect after a high-energy radiation enters into each one of the scintillation crystals; and, thus, energy of the high-energy radiation is fully absorbed by each one of the scintillation crystals to convert the high-energy radiation into a visible light or ultraviolet with energy conversion rate improved.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A scintillation crystal array, comprising a plurality of scintillation crystals,
wherein each one of said scintillation crystals has
at least one reflecting layer, said reflecting layer being located on surface of each one of said scintillation crystals; and
at least one shielding layer, said shielding layer being located on surface of said at least one reflecting layer,
wherein said at least one shielding layer connects said scintillation crystals to obtain the scintillation crystal array.

2. The scintillation crystal array according to claim 1,
wherein said reflecting layer is obtained through a method selected from a group consisting of spraying, pasting, sputtering and printing.

3. The scintillation crystal array according to claim 1,
wherein said reflecting layer is made of an alloy of a material selected from a group consisting of silver, aluminum, nickel, chromium and nickel-chromium.

4. The scintillation crystal array according to claim 1,
wherein said shielding layer is a glue made of a material selected from a group consisting of epoxy and polyvinyl acetate (PVA).

5. The scintillation crystal array according to claim 4,
wherein said glue further comprises a material selected from a group consisting of titanium dioxide (TiO₂), magnesium oxide (MgO) and barium sulfate (BaSO₄).

6. The scintillation crystal array according to claim 1,
wherein said shielding layer is made of a material selected from a group consisting of TiO₂, MgO and BaSO₄.

7. The scintillation crystal array according to claim 1,
wherein the scintillation crystal array is further covered with a thin film peripherally.
